(19) United States
(12) Patent Application Publication
(10) Pub. No.: US 2011/0010121 A1
(43) Pub. Date: Jan. 13, 2011

(54) MAGNETIC DATA PROCESSING DEVICE, MAGNETIC DATA PROCESSING METHOD, AND MAGNETIC DATA PROCESSING PROGRAM

(75) Inventor: IBUKI HANDA, Hamamatsu-shi (JP)

Correspondence Address: Dickstein Shapiro LLP, 2049 Century Park East, Suite 700, Los Angeles, CA, 90067, US

(73) Assignee: Yamaha Corporation, Hamamatsu-Shi (JP)

(21) Appl. No.: 12/819,508

(22) Filed: Jun. 21, 2010

(30) Foreign Application Priority Data
Jul. 10, 2009 (JP) 2009-164013

(51) Int. Cl. G06F 17/18; G01C 17/38

(52) U.S. Cl. 702/92; 702/179

(57) ABSTRACT

In a magnetic data processing device, an accumulating part sequentially acquires magnetic data output from a 3D magnetic sensor to provide a recent statistical population of the magnetic data. A past statistical population storage part stores, as a past statistical population, magnetic data output from the 3D magnetic sensor prior to the magnetic data accumulated as the recent statistical population. A determination part determines whether a distribution of the recent statistical population satisfies a certain condition, and determines whether a mixed statistical population of the past and recent statistical populations satisfies another condition when the recent statistical population does not satisfy the certain condition. An offset derivation part derives an offset of the magnetic data based on the recent statistical population when it satisfies the certain condition and derives an offset of the magnetic data based on the mixed statistical population when it satisfies said another condition. The past statistical population storage part updates the past statistical population using the recent statistical population.

### BACKGROUND OF THE INVENTION

1. Technical Field of the Invention

The present invention relates to a magnetic data processing device, a magnetic data processing method, and a magnetic data processing program, and more particularly to offset correction of three-dimensional Earth magnetic data.

2. Description of the Related Art

A conventional three-dimensional (3D) Earth magnetic sensor is mounted on a movable body such as a mobile phone to detect direction of the Earth's magnetic field. When a magnetic data processing device derives orientation based on magnetic data, the device needs to perform a process for correcting the magnetic data to eliminate measurement errors caused by magnetization of the movable body. A control value used for this correction process is derived based on a plurality of magnetic data and is referred to as an “offset”.

However, the magnetic data includes not only offset components caused by magnetization of the movable body but also error components caused by magnetic fields generated by electronic parts mounted in the movable body or caused by fluctuations of outputs of the magnetic sensor according to Gaussian distribution. Accordingly, to correctly derive a true offset caused by magnetization of the movable body, there is a need to store a plurality of magnetic data that are spread three-dimensionally over a wide range on a sphere. However, since special movement is required for the movable body to store such magnetic data, it is generally necessary for the user to perform an operation causing the movable body to make such a special movement. Since the true offset varies irregularly, orientation derived by the magnetic data processing device is likely to differ from the actual orientation unless the user frequently performs such an operation.

The present inventor has previously created an invention capable of deriving an offset close to the true offset without requiring the user to perform such a special operation (see Japanese Patent Application Publication No. 2007-240270). Japanese Patent Application Publication No. 2007-240270 describes a method in which an offset is derived three-dimensionally based on a statistical population of magnetic data when the distribution of the magnetic data of the statistical population is three-dimensional and an offset is derived two-dimensionally based on the statistical population of magnetic data when the distribution of the magnetic data of the statistical population is two-dimensional. In the case where the magnetic data of the statistical population is not spread three-dimensionally, this method two-dimensionally corrects, if the magnetic data of the statistical population is spread two-dimensionally, an offset derived in the past for a direction parallel to a plane in which the magnetic data is spread two-dimensionally.

### SUMMARY OF THE INVENTION

The present inventor has attempted to improve the technology described in Japanese Patent Application Publication No. 2007-240270 and has devised a method for deriving an offset which rapidly converges upon a true offset.

Thus, it is an object of the present invention to allow an offset of three-dimensional magnetic data to rapidly converge upon the true offset.

(1) A magnetic data processing device for achieving the above object comprises: an accumulating part that repeatedly accumulates a predetermined number of magnetic data to provide a recent statistical population, the predetermined number being four or greater, while sequentially acquiring magnetic data output from a three-dimensional (3D) magnetic sensor; a past statistical population storage part that stores, as a past statistical population, magnetic data output from the 3D magnetic sensor prior to the magnetic data accumulated as the recent statistical population; a determination part that determines, using a threshold (first threshold), whether or not a distribution of the recent statistical population satisfies a certain condition (first condition) each time the recent statistical population is provided, and that determines, using another condition (third threshold), whether or not a mixed statistical population composed of the past statistical population and the recent statistical population satisfies another condition (third condition) when the recent statistical population does not satisfy the first condition; and an offset derivation part that derives an offset of the magnetic data based on the recent statistical population when the recent statistical population satisfies the first condition and derives an offset of the magnetic data based on the mixed statistical population when the mixed statistical population satisfies the third condition, wherein the past statistical population storage part updates the past statistical population using at least part of the recent statistical population.

(2) Preferably, the determination part determines, using a still another threshold (second threshold), whether or not a distribution of the recent statistical population satisfies a still another condition (second condition), and the past statistical population storage part updates the past statistical population using at least part of the recent statistical population when the recent statistical population satisfies the second condition.

According to the invention, it is possible to derive the offset based on a mixed statistical population including a recent statistical population of an arbitrary time and a past statistical population which is a statistical population obtained prior to the arbitrary time. Accordingly, it is possible to derive the offset even when the recent statistical population of the arbitrary time is not widely spread to the extent that a probable offset can be derived based on the recent statistical population of the arbitrary time. In addition, since the past statistical population is not updated as long as the recent statistical population does not satisfy the second condition, it is likely that the mixed statistical population is widely spread to the extent that a probable offset can be derived therefrom. Further, it is possible to derive an offset close to the true offset since the offset can be derived based on the recent statistical population so as not to be affected by old magnetic data when the distribution of the recent statistical population is wide. That is, according to the invention, it is possible to allow the offset of 3D magnetic data to rapidly converge upon the true offset.

(3) In the magnetic data processing device for achieving the above object, the first condition indicates that the magnetic data contained in the recent statistical population are spread three-dimensionally, the third condition indicates that the magnetic data contained in the mixed statistical population are spread three-dimensionally, and the second condition indicates that the magnetic data contained in the recent statistical population are spread two-dimensionally. The past statistical population storage part updates the past statistical population using a copy of three or more magnetic data included the recent statistical population.

According to the invention, the time interval between the time when magnetic data of the recent statistical population is output from the 3D magnetic sensor and the time when magnetic data of the past statistical population is output from the 3D magnetic sensor is increased since the past statistical population is not updated as long as the recent statistical population is not spread two-dimensionally. Therefore, it is likely that magnetic data which is spread three-dimensionally is output from the magnetic sensor during a period in which the mixed statistical population including the recent statistical population and the past statistical population is stored. In addition, the overall distribution of a past statistical population and other magnetic data added thereto when the past statistical population is spread two-dimensionally is likely to be three-dimensional, compared to when the past statistical population is not spread two-dimensionally. Consequently, according to the invention, the distribution of the mixed statistical population including the past statistical population and the recent statistical population is likely to be three-dimensional. In addition, in the case where the distributions of the two statistical populations are all two-dimensional, the distance between the true offset and an offset that has been updated once based on the three-dimensionally distributed magnitude data of the mixed statistical population including the two statistical populations is smaller than the distance between the true offset and an offset that has been updated twice based on the two statistical populations using the method described in Japanese Patent Application Publication No. 2007-240270.

(4) In the case where the past statistical population is not updated when a recent statistical population at a specific time is not spread to a certain extent and is updated so as not to decrease the spread of the distribution of the recent statistical population, the distribution of a mixed statistical population including the past statistical population and the recent statistical population is wider than the distribution of the recent statistical population. Therefore, adding magnetic data, acquired from the magnetic sensor after the past statistical population is updated, to the past statistical population increases the possibility that the distribution of the mixed statistical population is three-dimensional.

Accordingly, in the magnetic data processing device for achieving the above object, the past statistical population storage part updates the past statistical population using a trimmed version of the recent statistical population from which the magnetic data are partly trimmed.

According to the invention, it is possible to reduce the amount of data of the past statistical population while suppressing the difference between the spread of the distribution of the past statistical population and the spread of the distribution of a statistical population, based on which the past statistical population is obtained.

(5) In the magnetic data processing device for achieving the above object, the magnetic data of the mixed statistical population are collected from the trimmed version of the recent statistical population and from the past statistical population such that the total number of the magnetic data contained in the mixed statistical population is set equal to the predetermined number of the magnetic data contained in the recent statistical population.

The invention simplifies the algorithm since the number of magnetic data of each statistical population used to derive the offset is equal.

The functions of each part described in the claims are implemented by hardware resources whose functions are specified by the configuration itself, hardware resources whose functions are specified by a program, or a combination thereof. The functions of each part are not limited to those implemented by physically independent hardware resources. The invention may also be applied to a magnetic data processing method, a magnetic data processing program, and a machine readable storage medium containing the magnetic data processing program. Of course, the storage medium containing the magnetic data processing program may be a magnetic recording medium or a magneto-optical recording medium and may be any other recording medium developed in the future.

### BRIEF DESCRIPTION OF THE DRAWINGS

FIG. 1 is a block diagram of an embodiment of the invention.

FIG. 2 is a flow chart of the embodiment of the invention.

FIG. 3 is a schematic diagram of the embodiment of the invention.

FIG. 4 is a schematic diagram of the embodiment of the invention.

FIG. 5 is a flow chart of the embodiment of the invention.

FIG. 6 is a schematic diagram of the embodiment of the invention.

### DETAILED DESCRIPTION OF THE INVENTION

Embodiments of the invention will now be described with reference to the accompanying drawings. Corresponding elements in each figure will be denoted by like reference numerals and a redundant description thereof will be omitted.

### 1. First Embodiment

### Overview

In the first embodiment of the invention, an offset is derived three-dimensionally based on a recent statistical population or a mixed statistical population when a distribution of magnetic data of the recent statistical population or the mixed statistical population is three-dimensional. On the other hand, when the distribution of magnetic data of the recent statistical population is two-dimensional, an offset derived in the past (i.e., old offset) is corrected two-dimensionally based on both the recent statistical population and the old offset and a mixed statistical population is generated from both the recent statistical population and the past statistical population.

### (Configuration of Magnetic Data Processing Device)

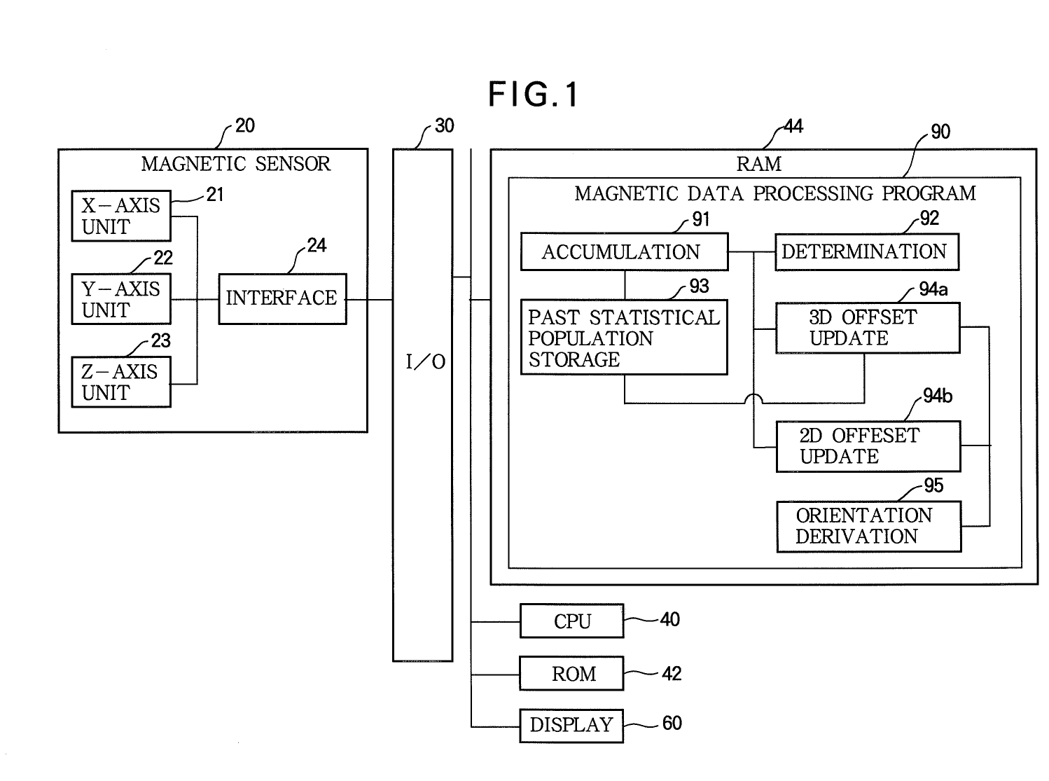

FIG. 1 is a block diagram illustrating an embodiment of a magnetic data processing device of the invention. The magnetic data processing device 1 is mounted on a portable information terminal such as a mobile phone, a Personal Navigation Device (PND), an electronic compass, or a digital camera.

The magnetic data processing device 1 includes a magnetic sensor 20 and a microcomputer. The microcomputer includes a CPU 40, a ROM 42, a RAM 44, an input/output unit (I/O) 30, and the like. The magnetic data processing device 1 receives magnetic data output from the magnetic sensor 20 and outputs orientation data to visually or audibly inform the user of a travel direction or an expected travel route based on offset-corrected magnetic data. A display unit 60 includes a display panel and a display driver for displaying an image indicating the orientation.

The magnetic sensor 20 is a 3D magnetic sensor including an x-axis sensor 21, a y-axis sensor 22, and a z-axis sensor 23, which detect three orthogonal axis components of a magnetic field vector, and an interface 24. The x-axis sensor 21, the y-axis sensor 22, and the z-axis sensor 23 each include a magnetic resistance element, a hall element, or the like and may each be any type of linear 1D magnetic sensor. The x-axis sensor 21, the y-axis sensor 22, and the z-axis sensor 23 are fixed such that sensing directions thereof are orthogonal to each other. The interface 24 receives outputs of the x-axis sensor 21, the y-axis sensor 22, and the z-axis sensor 23 through time division and performs amplification and AD conversion on the received outputs of the three sensors 21, 22, and 23 to output magnetic data q=(qₓ, q_{y}, q_{z}). The magnetic data q, which is a digital signal output from the interface 24, is stored in the RAM 44 at a specific address. The ROM 42, which is a nonvolatile storage medium, stores a magnetic data processing program 90, which is loaded into the RAM 44 and executed by the CPU 40, or a variety of programs for implementing functions of the portable information terminal.

The magnetic data processing program 90 is a program for outputting orientation data based on magnetic data and is stored in the ROM 42. The orientation data is vector data indicating the direction of the Earth's magnetic field. The magnetic data processing program 90 includes a group of modules such as an accumulating module 91, a determination module 92, a past statistical population storage module 93, a 3D offset update module 94a, a 2D offset update module 94b, and an orientation derivation module 95.

The accumulating module 91 is a program module that implements a function to repeatedly store N magnetic data q₁, . . . , q_{N} (N≦4) as a recent statistical population, while sequentially acquiring magnetic data output from the 3D magnetic sensor. That is, the accumulating module 91 implements a function to sequentially acquire magnetic data output from the magnetic sensor 20 at regular time intervals and to store the acquired magnetic data in a recent buffer. The recent buffer is a storage region in the RAM 44 for accumulating a predetermined number of magnetic data, the predetermined number being four or more.

The determination module 92 is a program module that implements a function to determine, each time a recent statistical population is provided, whether or not a distribution of the recent statistical population satisfies a first condition using a first threshold while determining whether or not the distribution of the recent statistical population satisfies a second condition using a second threshold and to determine whether or not a mixed statistical population including the recent and past statistical populations satisfies a third condition using a third threshold in case that the recent statistical population does not satisfy the first condition. The mixed statistical population includes a set of magnetic data, which is obtained by trimming a plurality of magnetic data constituting the recent statistical population of the latest time in half in the order in which the magnetic data is acquired, and a set of magnetic data constituting the past statistical population.

For example, in case that the recent statistical population contains N magnetic data q₁, q₂, q₃, q₄, q₅, . . . , q_{N}, only magnetic data q₁, q₃, q₅, . . . , q_{N-1} are extracted while magnetic data q₂, q₄, q₆, . . . , q_{N} are trimmed away. The past statistical population includes a recent statistical population obtained in the past and it is assumed in this embodiment that the past statistical population is a set of magnetic data obtained by trimming the recent statistical population obtained in the past in half. Since the mixed statistical population is defined as such a data set, the number of magnetic data of the mixed statistical population is equal to the number of magnetic data of the recent statistical population and therefore it is possible to apply common program code to implement functions to determine distribution characteristics of the statistical population and to derive the offset.

Here, examples of the above noted recent statistical population and past statistical population are given below for better understanding of these terms. In case that N pieces of magnetic data q_{1′}, q_{2′}. . . , q_{N′}are sequentially accumulated, and then N pieces of magnetic data q₁, q₂ . . . , q_{N} are sequentially accumulated, the past statistical population is formed by N/2 pieces of magnetic data q_{1′}, q_{3′}, q_{5′}. . . , q_{N′}which are extracted, for example, alternately from the first group of the magnetic data q_{1′}, q_{2′}. . . , q_{N′},and the recent statistical population is formed by the newest group of the magnetic data q₁, q₂ . . . , q_{N}. In this case, the mixed statistical population is formed of N/2 magnetic data q_{1′}, q_{3′}, q_{5′}. . . , q_{N-1′}, contained in the past statistical population and N/2 magnetic data q₁, q₃, q₅ . . . , q_{N-1}, which are extracted, for example, alternately from the recent statistical population containing the magnetic data q₁, q₂ . . . , q_{N}. Therefore, the mixed statistical population is composed of N pieces of magnetic data q_{1′}, q_{3′}, q_{5′}. . . , q_{N-1′}and q₁, q₃ q₅ . . . , q_{N-1}. In the disclosed example, N/2 pieces of magnetic data are collected by extracting odd number of magnetic data from the magnetic data group containing N magnetic data. Otherwise, even number of magnetic data may be extracted to form the past statistical population or to form the mixed statistical population, or other method may be adopted to extract the magnetic data.

In this embodiment, ratios between three principal values of the distribution of a statistical population are used as indices of the distribution of the statistical population, and the determination module 92 determines distribution characteristics of the statistical population by comparing each of the indices with a corresponding predetermined threshold. Specifically, the determination module 92 determines distribution characteristics of the statistical population in the following manner. Principal values of the distribution of a statistical population q₁, . . . , q_{N} correspond respectively to eigenvalues λ₁, λ₂, and λ₃ (λ₁≧λ₂≧λ₃) of a symmetric matrix A defined by the following equations (1), (2), and (3).

$$\begin{matrix}A = {X}^{T} X \\ where & ( 1 ) \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] & ( 2 ) \\ \overline{q} = \frac{1}{N} {\sum }_{i = 1}^{N} {q}_{i} . & ( 3 )\end{matrix}$$

In addition, λ₃/λ₁ is defined as an index indicating the extent to which the statistical population is distributed three-dimensionally. Also, λ₂/λ₁ is defined as an index indicating the extent to which the statistical population is distributed two-dimensionally. The determination module 92 determines that the statistical population is distributed three-dimensionally when λ₃/λ₁ is greater than a predetermined threshold. That is, the determination module 92 determines that the recent statistical population satisfies the first condition and the mixed statistical population satisfies the third condition. The determination module 92 determines that the statistical population is distributed two-dimensionally when λ₃/λ₁ is not greater than the predetermined threshold and λ₂/λ₁ is greater than another predetermined threshold. That is, the determination module 92 determines that the recent statistical population satisfies the second condition. The symmetric matrix A corresponds to N times a variance-covariance matrix since the symmetric matrix A is also written as in Equation (4).

$$A = {\sum }_{i = 1}^{N} ( {q}_{i} - \overline{q} ) {( {q}_{i} - \overline{q} )}^{T} \qquad ( 4 )$$

The past statistical population storage module 93 is a program module that implements a function to store, as a past statistical population, magnetic data output from the magnetic sensor 20 prior to magnetic data of the recent statistical population and to update the past statistical population with at least a part of the recent statistical population when the recent statistical population satisfies the second condition. Specifically, when the recent statistical population satisfies the second condition, the past statistical population storage module 93 trims magnetic data elements constituting the recent statistical population in half in the order in which the magnetic data elements are acquired, and stores the trimmed recent statistical population as a past statistical population in a past buffer. For example, in case that the recent statistical population contains N magnetic data q₁, q₂, q₃, q₄, q₅, . . . , q_{N}, only magnetic data q₁, q₃, q₅, . . . , q_{N-1} are extracted to update the past statistical population while magnetic data q₂, q₄, q₆, . . . , q_{N} are trimmed away. The past buffer is a storage region in the RAM 44 for storing a predetermined number of magnetic data elements, separately from the recent statistical population.

The 3D offset update module 94a is a program module that implements a function to derive an offset three-dimensionally based on the recent statistical population or the mixed statistical population. Specifically, the 3D offset update module 94a derives the offset in the following manner. In each equation, the recent statistical population and the mixed statistical population will each be represented by q₁, . . . , q_{N}.

When the statistical population includes four magnetic data elements that are not in the same line, a sphere on which the statistical population is distributed is uniquely specified without using a statistical method. A position vector p=(pₓ, p_{y}, p_{z}) of the center of the sphere is obtained by solving simultaneous equations (5). Although the number of equality constraints is four for three variables, the equations (5) must have a solution since one of the four equality constraints is redundant.

$$\begin{matrix}[ \begin{matrix}{( {q}_{1} - \overline{q} )}^{T} \\ {( {q}_{2} - \overline{q} )}^{T} \\ {( {q}_{3} - \overline{q} )}^{T} \\ {( {q}_{4} - \overline{q} )}^{T}\end{matrix} ] p = \frac{1}{2} [ \begin{matrix}{q}_{1}^{T} {q}_{1} - R \\ {q}_{2}^{T} {q}_{2} - R \\ {q}_{3}^{T} {q}_{3} - R \\ {q}_{4}^{T} {q}_{4} - R\end{matrix} ] \\ where & ( 5 ) \\ R = \frac{1}{N} {\sum }_{i = 1}^{N} {q}_{i}^{T} {q}_{i} & ( 6 )\end{matrix}$$

Here, if simultaneous linear equations (7) for “p” have a solution when the number of data elements of the statistical population is five or more, the solution is the center of the sphere on which the data set of the statistical population is distributed.

$$\begin{matrix}{x}_{p} = j , \\ where & ( 7 ) \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] . & ( 8 )\end{matrix}$$

However, the equation (7) rarely has a solution when measurement errors of the magnetic sensor 20 are taken into consideration. Thus, let us introduce a vector “e” defined as in the following equation (9) in order to obtain a feasible solution using a statistical method.

e=Xp−j (9)

The value of “p” which minimizes ∥e∥₂² (i.e., e^{T}e) is likely to be the center of a sphere, to which the statistical population is distributed closest. When the matrix A is regular, the problem of obtaining the value of “p” which minimizes ∥e∥₂² is an optimization problem of minimizing an objective function of the following Equation (10).

f(p)=(Xp −j)^{T}(Xp−j) (10)

That is, the value of “p” which minimizes the objective function f(p) of Equation (10) is derived as an offset. The value of “p” which minimizes the objective function f(p) can be written as the following Equation (11) when X^{T}X is regular as assumed in this embodiment.

p=(X^{T}X)⁻¹X^{T}j (11)

The 2D offset update module 94b is a program module that implements a function to derive a latest offset by correcting a past offset two-dimensionally based on the recent statistical population. That is, the 2D offset update module 94b implements a function to derive a latest offset based on both the recent statistical population stored in the accumulating module 91 and the past offset and to update the past offset with the latest offset. Specifically, the 2D offset update module 94b derives the latest offset in the following manner.

When the distribution of the statistical population is two-dimensional (i.e., planar), a new offset is derived by restricting directions in which the old offset is corrected to two orthogonal directions. In the case where the statistical population is distributed concentrating on a specific plane and is spread when viewed from a direction perpendicular to the plane, the statistical population in a direction parallel to the plane is sufficiently reliable while the statistical population in the direction perpendicular to the plane is unreliable as a data set used for offset correction. In this case, the old offset is not corrected in the direction perpendicular to the plane, thereby preventing the offset from being updated based on unreliable information.

In case that the statistical population is concentrated about a specific plane and is spread when viewed from a direction perpendicular to the plane, the direction perpendicular to the plane is coincident with the direction of an eigenvector u₃ corresponding to the minimum eigenvalue λ₃ and two orthogonal directions parallel to the plane are coincident with the directions of eigenvectors u₁ and u₂ corresponding respectively to the maximum eigenvalue λ₁ and the intermediate eigenvalue λ₂. Accordingly, in order to derive a new offset p without correcting the old offset p₀ in the direction perpendicular to the plane, a new offset p which minimizes the objective function of Equation (10) is found under a constraint condition expressed by the following equation (12).

p=p₀+β₁u₁+β₂u₂(β₁,β₂: real numbers) (12)

Equation (12) is equivalent to the following equation (13).

u₃^{T}(p−p₀)=0 (13)

The equation for solving the optimization problem of Equation (10) under the constraint condition of Equation (13) can be modified to its equivalent simultaneous equations using the method of Lagrange multipliers. When a Lagrange undetermined multiplier p is introduced and “x” is defined by the following equation (14), simultaneous linear equations (15) of “x” are the above-mentioned simultaneous equations.

$$\begin{matrix}x = [ \begin{matrix}p \\ ρ\end{matrix} ] & ( 14 ) \\ {B}_{4} x = {b}_{4} \\ where & ( 15 ) \\ {B}_{4} = [ \begin{matrix}A & {u}_{3} \\ {u}_{3}^{T} & 0\end{matrix} ] & ( 16 ) \\ {b}_{4} = [ \begin{matrix}{X}^{T} & j \\ {u}_{3}^{T} & {p}_{0}\end{matrix} ] . & ( 17 )\end{matrix}$$

The orientation derivation module 95 is a program module that generates orientation data by correcting magnetic data sequentially acquired from the magnetic sensor 20 using the latest offset. Specifically, the orientation derivation module 95 outputs, as the orientation data, vector data obtained by subtracting components of the offset from components of the magnetic data which is vector data.

### (Magnetic Data Processing Method)

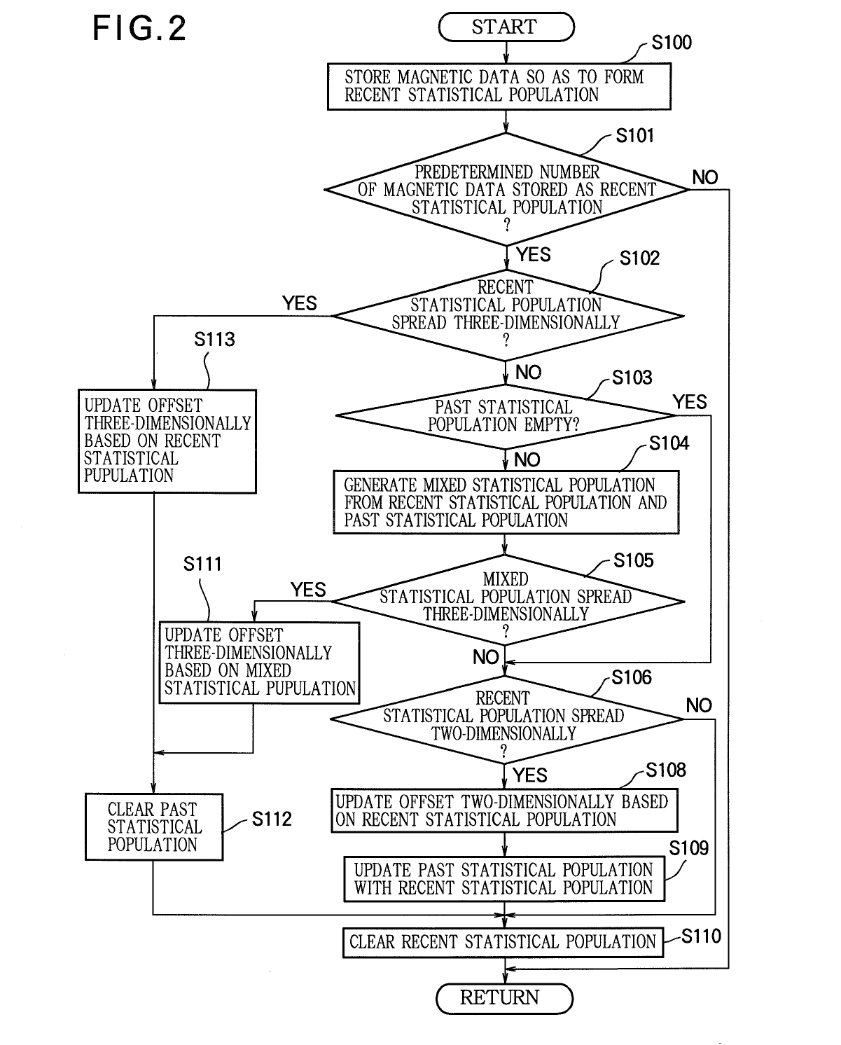

Next, a magnetic data processing method, which is implemented by executing the magnetic data processing program 90, is described with reference to FIG. 2. A procedure of FIG. 2 is repeatedly performed at regular time intervals (for example, at intervals of 10 milliseconds).

First, the accumulating module 91 acquires magnetic data output from the magnetic sensor 20 and stores the acquired magnetic data in the recent buffer (S100).

Then, the determination module 92 determines whether or not a predetermined number of magnetic data has been accumulated as a recent statistical population in the recent buffer (S101). When the predetermined number of magnetic data has not yet been accumulated as a recent statistical population in the recent buffer, next magnetic data is stored in the recent buffer after a predetermined time has elapsed (S100).

When the predetermined number of magnetic data has been stored as a recent statistical population in the recent buffer, the determination module 92 determines whether or not the recent statistical population is spread three-dimensionally (S102).

When the recent statistical population is spread three-dimensionally, the offset is updated three-dimensionally based only on the recent statistical population (S113). That is, the 3D offset update module 94a derives a latest offset using the magnetic data stored in the recent buffer as a statistical population and updates the past offset with the latest offset.

The 3D offset update module 94a discards the past statistical population when the offset has been updated three-dimensionally based only on the recent statistical population (S112). The purpose of this is to reduce, when the true offset has changed due to change of the magnetization status, the time during which the offset is derived based on magnetic data acquired before change of the true offset, while allowing the offset to rapidly converge upon the changed true offset.

When the recent statistical population is not spread three-dimensionally, the determination module 92 determines whether or not the past statistical population is empty (S103).

When the past statistical population is not empty, the determination module 92 generates a mixed statistical population from both the recent statistical population and the past statistical population (S104). Specifically, magnetic data stored in the recent and past buffers is stored as a mixed statistical population in a different storage region.

When the mixed statistical population has been generated from the recent statistical population and the past statistical population, the determination module 92 determines whether or not the mixed statistical population is spread three-dimensionally (S105).

When the mixed statistical population is spread three-dimensionally, the offset is updated three-dimensionally based only on the mixed statistical population (S111). That is, the 3D offset update module 94a derives a latest offset using, as a statistical population, magnetic data of both the recent statistical population of the past time and the recent statistical population of the latest time and updates the past offset with the latest offset. The 3D offset update module 94a then discards the past statistical population when the past offset has been updated with the latest offset (S112).

When the past statistical population is empty or when the mixed statistical population is not spread three-dimensionally, the determination module 92 determines whether or not the recent statistical population is spread two-dimensionally (S106).

When the recent statistical population is spread two-dimensionally, the offset is updated by correcting the old offset two-dimensionally based on the recent statistical population (S108). That is, the 2D offset update module 94b updates the offset with the solution “p” of simultaneous linear equations (15).

When the recent statistical population is spread two-dimensionally, the past statistical population is updated with the recent statistical population (S109). That is, the past statistical population storage module 93 selects half the magnetic data from the recent statistical population and stores the selected magnetic data in the past buffer.

Finally, the accumulating part 91 discards the recent statistical population (S110).

In the above procedure, the past statistical population is not updated if the recent statistical population is spread neither three-dimensionally nor two-dimensionally. Accordingly, the past statistical population is not updated and the offset is also not derived when the magnetic sensor 20 moves neither three-dimensionally nor two-dimensionally. Since the recent statistical population is stored as a past statistical population only when the recent statistical population is spread two-dimensionally, it is likely that the mixed statistical population including the recent statistical population and the past statistical population is spread three-dimensionally. Thus, useless offset update processes are prevented in this embodiment.

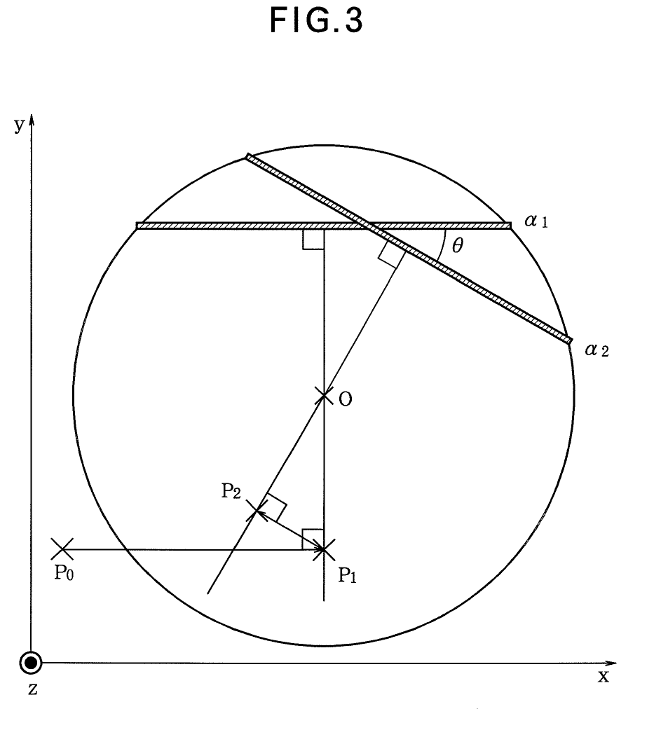

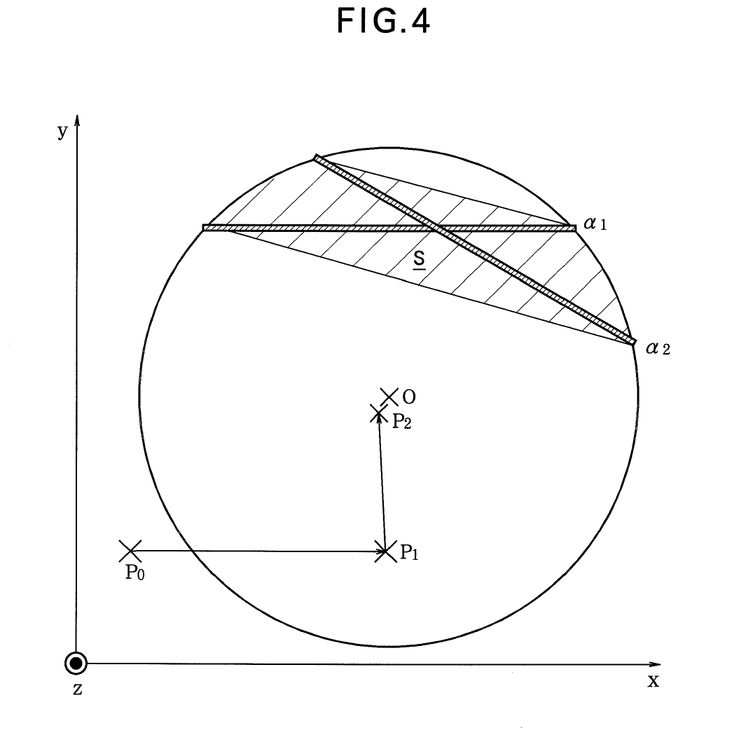

Here, let us assume that, when a plurality of statistical populations which are spread two-dimensionally has been stored, the past offset is corrected two-dimensionally based on each of the statistical populations. In this case, when the angle θ between planes α₁ and α₂ about which the statistical populations are spread is small, the offset is sequentially updated to p₀, p₁, and p₂ as shown in FIG. 3, whereby the offset is difficult to approach the true offset ◯. On the other hand, in this embodiment, since the offset is derived three-dimensionally based on a three-dimensional distribution S including the planes α₁ and α₂ about which the statistical populations are spread, the offset is updated sequentially to p₀, p₁, and p₂, rapidly converging upon the true offset ◯, as shown in FIG. 4.

### 2. Second Embodiment

In the second embodiment of the invention, an offset is derived three-dimensionally based on a recent statistical population or a mixed statistical population when a distribution of magnetic data of the recent statistical population or the mixed statistical population is three-dimensional. On the other hand, an old offset is not corrected while the mixed statistical population is generated from both the recent statistical population and the past statistical population when the distribution of magnetic data of the recent statistical population is two-dimensional.

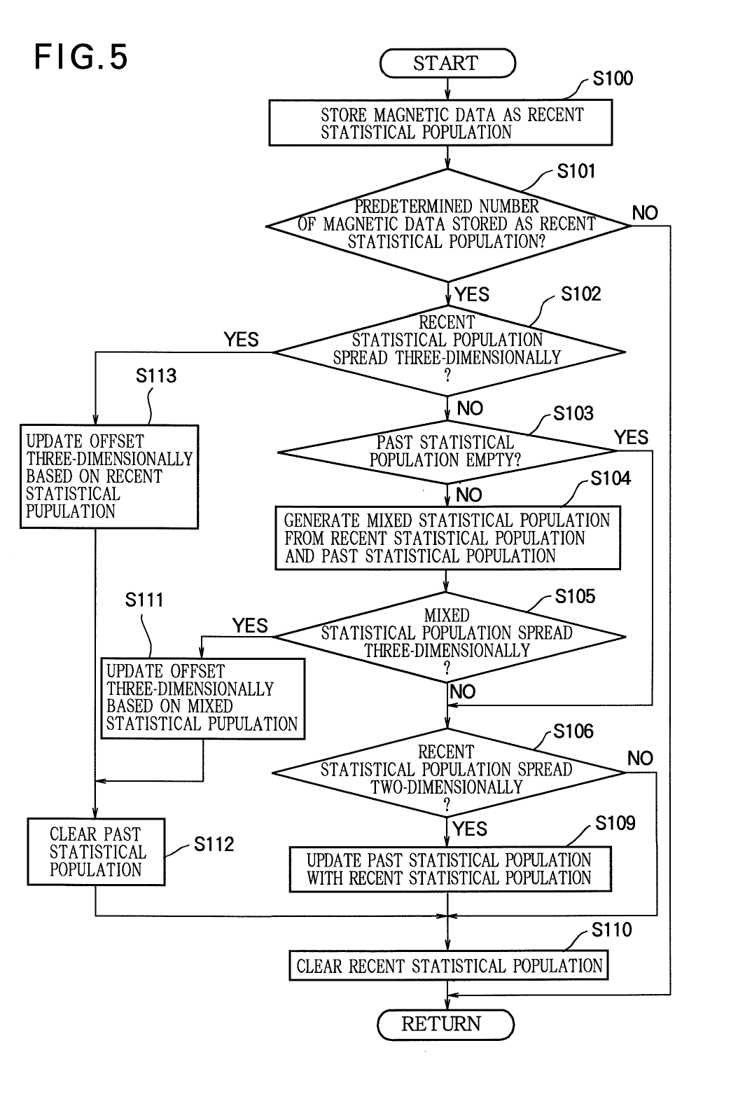

FIG. 5 is a flow chart illustrating a magnetic data processing method according to the second embodiment. That is, the second embodiment differs from the first embodiment in that the process of step S108 for deriving an offset based on the recent statistical population is not performed.

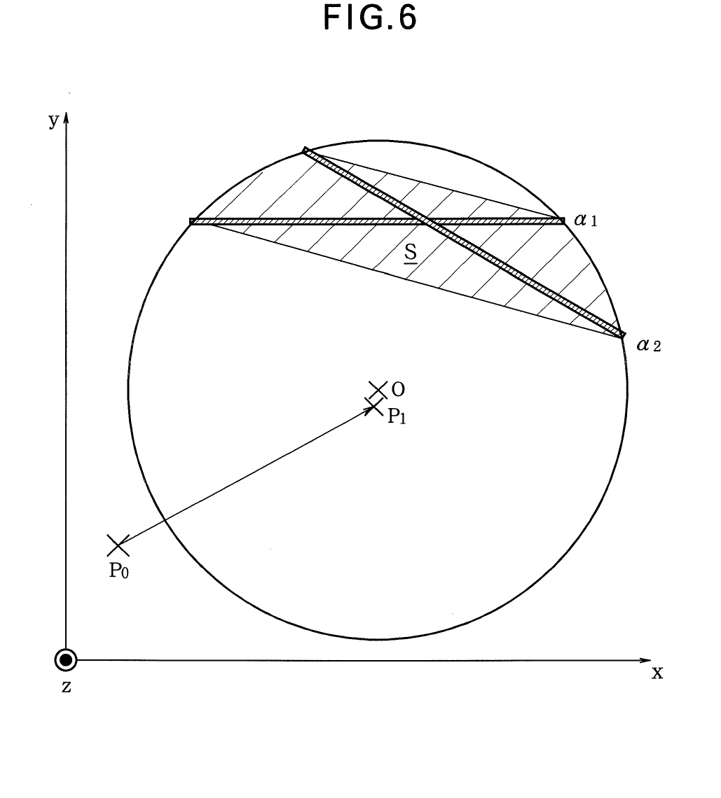

Since the process for correcting the past offset two-dimensionally is not performed, the offset is sequentially updated to p₀ and p₁ as shown in FIG. 6 in this embodiment in the case where the offset is updated to p₀, p₁, and p₂ as shown in FIG. 4 in the first embodiment.

### 3. Other Embodiments

The scope of the invention is not limited to the above embodiments and various modifications can be made without departing from the spirit of the invention.

For example, the part for deriving the offset three-dimensionally based on a statistical population and the part for correcting the old offset two-dimensionally based on a statistical population are not limited to those described in the above embodiments, any known means may be used, and any means that will be developed in the future may also be used. Examples of the known means include a means for deriving an offset two-dimensionally or three-dimensionally using a statistical method, a means for selecting three or four magnetic data from a statistical population and obtaining, from the selected statistical population, the center of a sphere as an offset or the center of a circle as a temporary offset for correcting the old offset, etc. The present inventor has previously suggested a plurality of methods for deriving the offset of magnetic data (Japanese Patent Application Publication Nos. 2007-240270, 2007-205944, 2007-139715, 2007-107921, 2007-339478, etc).

For example, the means for determining whether or not the statistical population is spread three-dimensionally or two-dimensionally is not limited to that described in the above embodiments, any known means may be used, and any means that will be developed in the future may also be used. Examples of the known means include a means for comparing the magnitude of variance (or dispersion) of the statistical population with a threshold. Whether or not each of the past statistical population and the recent statistical population is spread three-dimensionally may be determined using an individual threshold and may also be determined using a modified algorithm.

In addition, for example, after an offset is derived based on a statistical population, the reliability of the offset may be determined using a threshold and the derived offset may be discarded when the reliability is low.

Further, for example, the condition of the recent statistical population that should be satisfied to update the past statistical population is not limited to that described in the above embodiments where the magnetic data spread two-dimensionally and any other condition may be employed, provided that the mixed statistical population is likely to be spread three-dimensionally and old magnetic data is not left as a past statistical population over a long period exceeding an appropriate range. Namely, the past statistical population may be updated in case that the recent statistical population is spread three-dimensionally. Otherwise, the past statistical population may be updated in case that the recent statistical population satisfies a certain condition even if the recent statistical population is not spread two-dimensionally. For example, in the case where the characteristics of distribution of the recent statistical population are employed as the condition, a state in which the magnitude of the variance thereof has exceeded a threshold or the like may also be used as the condition. In addition, the length of the time interval between the time when the recent statistical population is stored and the time when the past statistical population is stored may be used as the condition. That is, the past statistical population may be updated with the recent statistical population at regular time intervals.

Furthermore, for example, a set of magnetic data which is obtained by trimming a plurality of magnetic data constituting the recent statistical population in any order may be defined as a past statistical population and the entirety of the recent statistical population may be stored as a past statistical population. The past statistical population may also include only one magnetic data. For example, only oldest magnetic data of the recent statistical population may be stored as a past statistical population. In addition, the number of magnetic data of a mixed statistical population may be different from the number of magnetic data of a recent statistical population. For example, a combination of a past statistical population, including all magnetic data of a recent statistical population of a past time, and all magnetic data of a recent statistical population of a latest time may be defined as a mixed statistical population.

Moreover, the past statistical population may be cleared at times other than the time when the offset is updated three-dimensionally. For example, the past statistical population may be cleared at regular time intervals. Further, for example, the magnetic sensor and the microcomputer may be incorporated into a single package, constructing a magnetic data processing device as an independent electronic part that outputs orientation data. Furthermore, the orientation data may be derived, for example, by correcting the offset according to temperature characteristics of the magnetic sensor 20. Moreover, magnetic data to be stored as a recent statistical population may also be selected. For example, only one of two consecutively acquired magnetic data is stored as a recent statistical population when the distance between the two consecutively acquired magnetic data is small.

What is claimed is:

1. A magnetic data processing device comprising:
an accumulating part that repeatedly accumulates a predetermined number of magnetic data to provide a recent statistical population, the predetermined number being four or greater, while sequentially acquiring magnetic data output from a three-dimensional (3D) magnetic sensor;
a past statistical population storage part that stores, as a past statistical population, magnetic data output from the 3D magnetic sensor prior to the magnetic data accumulated as the recent statistical population;
a determination part that determines, using a threshold, whether or not a distribution of the recent statistical population satisfies a certain condition each time the recent statistical population is provided, and that determines, using another threshold, whether or not a mixed statistical population composed of the past statistical population and the recent statistical population satisfies another condition when the recent statistical population does not satisfy the certain condition; and
an offset derivation part that derives an offset of the magnetic data based on the recent statistical population when the recent statistical population satisfies the certain condition and derives an offset of the magnetic data based on the mixed statistical population when the mixed statistical population satisfies said another condition,
wherein the past statistical population storage part updates the past statistical population using at least part of the recent statistical population.

2. The magnetic data processing device according to claim 1,
wherein the determination part determines, using a still another threshold, whether or not the distribution of the recent statistical population satisfies a still another condition, and
wherein the past statistical population storage part updates the past statistical population using at least part of the recent statistical population when the recent statistical population satisfies said still another condition.

3. The magnetic data processing device according to claim 2,
wherein the certain condition indicates that the magnetic data contained in the recent statistical population are spread three-dimensionally, said another condition indicates that the magnetic data contained in the mixed statistical population are spread three-dimensionally, and said still another condition indicates that the magnetic data contained in the recent statistical population are spread two-dimensionally, and
wherein the past statistical population storage part updates the past statistical population using a copy of three or more magnetic data included in the recent statistical population.

4. The magnetic data processing device according to claim 1, wherein the past statistical population storage part updates the past statistical population using a trimmed version of the recent statistical population from which the magnetic data are partly trimmed.

5. The magnetic data processing device according to claim 4, wherein the magnetic data of the mixed statistical population are collected from the trimmed version of the recent statistical population and from the past statistical population such that the total number of the magnetic data contained in the mixed statistical population is set equal to the predetermined number of the magnetic data contained in the recent statistical population.

6. The magnetic data processing device according to claim 1, further comprising the 3D magnetic sensor.

7. A magnetic data processing method comprising:
repeatedly accumulating a predetermined number of magnetic data to provide a recent statistical population, the predetermined number being four or greater, while sequentially acquiring magnetic data output from a three-dimensional (3D) magnetic sensor;
storing, as a past statistical population, magnetic data output from the 3D magnetic sensor prior to the magnetic data accumulated as the recent statistical population;
determining, using a threshold, whether or not a distribution of the recent statistical population satisfies a certain condition each time the recent statistical population is provided, and determining, using another threshold, whether or not a mixed statistical population composed of the past statistical population and the recent statistical population satisfies another condition when the recent statistical population does not satisfy the certain condition;
deriving an offset of the magnetic data based on the recent statistical population when the recent statistical population satisfies the certain condition, and deriving an offset of the magnetic data based on the mixed statistical population when the mixed statistical population satisfies said another condition; and
updating the past statistical population using at least part of the recent statistical population.

8. A machine readable storage medium for use in a computer, the medium containing a magnetic data processing program which is executable by the computer to perform a process of:
repeatedly accumulating a predetermined number of magnetic data to provide a recent statistical population, the predetermined number being four or greater, while sequentially acquiring magnetic data output from a three-dimensional (3D) magnetic sensor;
storing, as a past statistical population, magnetic data output from the 3D magnetic sensor prior to the magnetic data accumulated as the recent statistical population;
determining, using a threshold, whether or not a distribution of the recent statistical population satisfies a certain condition each time the recent statistical population is provided, and determining, using another threshold, whether or not a mixed statistical population composed of the past statistical population and the recent statistical population satisfies another condition when the recent statistical population does not satisfy the certain condition;
deriving an offset of the magnetic data based on the recent statistical population when the recent statistical population satisfies the certain condition, and deriving an offset of the magnetic data based on the mixed statistical population when the mixed statistical population satisfies said another condition; and
updating the past statistical population using at least part of the recent statistical population.
